(19) United States
(12) Patent Application Publication
(10) Pub. No.: US 2026/0093159 A1
(43) Pub. Date: Apr. 2, 2026

(54) LENS PARAMETER ADJUSTMENT DEVICE

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/332,509

(22) Filed: Sep. 18, 2025

(30) Foreign Application Priority Data
Sep. 30, 2024 (CN) 2024224323244

(51) Int. Cl. G03B 13/18

(52) U.S. Cl. CPC G03B 13/18

(57) ABSTRACT

The present disclosure relates to a lens parameter adjustment device in the field of photographic auxiliary equipment. The device includes a first main body, a second main body, and a quick-release assembly. The first main body includes a retaining groove. The quick-release assembly includes a retaining member and a trigger. Both the trigger and the retaining member are movably connected to the second main body, and the trigger is in contact with the retaining member. The trigger is configured to actuate the retaining member to engage with or disengage from the wall of the retaining groove. Through the cooperation between the quick-release assembly and the retaining groove, the first and second main body s can be detachably connected, forming two separate modules. This design enhances portability, facilitates shooting and component replacement, improves flexibility, and significantly increases user convenience.

### CROSS-REFERENCE TO RELATED APPLICATIONS

The present application for patent claims priority to and the benefit of Chinese Application No. 2024224323244, filed September 30, 2024, which is hereby incorporated by reference herein as if fully set forth below in its entirety and for all applicable purposes.

### TECHNICAL FIELD

The present disclosure pertains to the field of photographic auxiliary equipment, especially to a lens parameter adjustment device.

### INTRODUCTION

In photography, users often need to adjust lens parameters such as zoom, focus, and aperture to achieve different compositions and effects. This typically involves rotating the lens to capture the desired image. To facilitate such adjustments, parameter adjustment devices such as follow focus units have been developed. These devices generally include a main body and a handwheel, allowing the user to hold the main body with one hand while adjusting the handwheel with the other. However, in existing devices, the main body and the handwheel are often fixedly connected, resulting in limited functionality and inconvenience during use.

### BRIEF SUMMARY

To address the aforementioned issues, the present disclosure provides a lens parameter adjustment device that offers greater flexibility in use.

Some aspects of the present disclosure provide a lens parameter adjustment device, including a first main body, a second main body, and a first quick-release assembly.

The first main body includes a retaining groove.

The first quick-release assembly is movably connected to the second main body and includes a first retaining member and a first trigger. The first trigger is operable to actuate the first retaining member to engage with or disengage from the wall of the retaining groove.

The first main body and the second main body are configured such that one of them includes a body unit, and the other includes a handwheel.

Advantageous Effects: Compared to existing technologies, the cooperation between the quick-release assembly and the retaining groove allows the first and second main body s to be detachably connected, forming two separate modules. This design improves portability, facilitates shooting and replacement, enhances flexibility, and significantly increases user convenience.

### BRIEF DESCRIPTION OF THE DRAWINGS

FIG. 1 is a diagram illustrating a follow focus unit according to some aspects of the disclosure.

FIG. 2 is a diagram illustrating a handwheel according to some aspects of the disclosure.

FIG. 3 is a diagram illustrating a quick-release assembly, terminals, a circuit board, and a mounting block according to some aspects of the disclosure.

FIG. 4 is an exploded view illustrating the quick-release assembly and the mounting block of FIG. 3 according to some aspects of the disclosure.

FIG. 5 is a diagram illustrating a first view of a body unit according to some aspects of the disclosure.

FIG. 6 is a diagram illustrating a second view of the body unit of FIG. 5 according to some aspects of the disclosure.

FIG. 7 is a diagram illustrating a disassembled quick-release assembly according to some aspects of the disclosure.

FIG. 8 is a cross-sectional view of the disassembled quick-release assembly according to some aspects of the disclosure.

FIG. 9 is an exploded view of a parameter adjustment device according to some aspects of the disclosure.

FIG. 10 is another exploded view of the parameter adjustment device according to some aspects of the disclosure.

Reference Numerals: 1. body unit; 11. retaining groove; 12. notch; 13. mounting groove; 14. second connector; 15. elastic plug; 16. interface; 17. quick-release locking member; 171. locking part; 18. positioning port;

2. handwheel; 21. mounting block; 211. limiting slide groove; 212. sliding limiting boss; 2121. side surface; 2122. top surface; 22. handwheel main body; 23. base plate; 231. mounting boss; 232. terminal through-hole; 24. first connector; 25. circuit board;

3. first quick-release assembly; 31. first retaining member; 311. latch hook; 312. sliding limiting surface; 3121. first sliding limiting surface; 3122. second sliding limiting surface; 32. first trigger member;

4. opening; 41. first opening; 42. second opening;

5. mounting chamber;

6. second quick-release assembly; 61. second retaining member; 62. second trigger member;

7. extension bracket; 71. connector; 72. bracket; 73. knob.

### DETAILED DESCRIPTION

To clarify the technical solutions and aspects of the present disclosure, the following description is provided with reference to the accompanying drawings and illustrative embodiments. It should be understood that the specific embodiments described herein are provided for the purposes of illustration and not intended to limit the scope of the present disclosure.

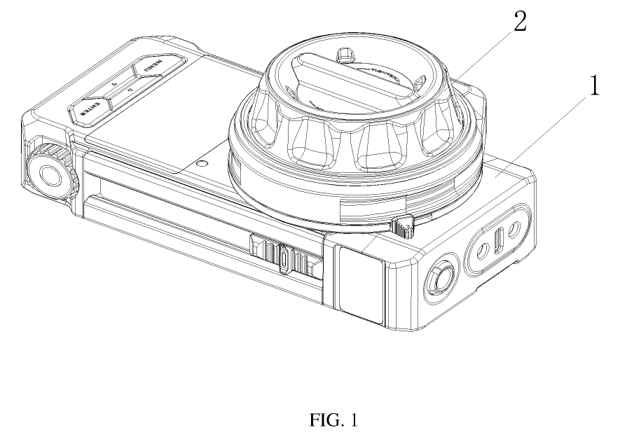

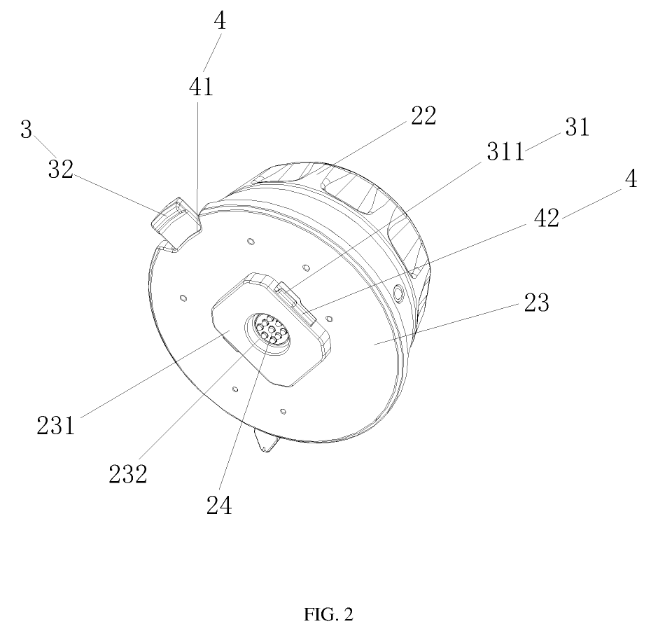

Referring to FIG. 1–8, some aspects of the disclosure provide a lens parameter adjustment device, such as a follow focus unit. As shown in FIG. 1–4, the device includes: a body unit 1, a handwheel 2, and a first quick-release assembly 3.

The body unit 1 serves as the first main body and includes a retaining groove 11.

The handwheel 2 serves as the second main body.

The first quick-release assembly 3 includes a first retaining member 31 and a first trigger member 32. Both the first trigger member 32 and the first retaining member 31 are movably connected to the handwheel 2. The first trigger member 32 is in contact with the first retaining member 31 and is operable to actuate the first retaining member 31 to engage with or disengage from the wall of the retaining groove 11.

In some aspects, an extension bracket 7 can also be included as the second main body.

In some aspects, the body unit 1 and the handwheel 2 of the follow focus unit are designed as two separate modules to allow flexible configuration. During assembly, the user operates the first trigger 32 to drive the first retaining member 31 to move, enabling the first retaining member 31 to enter the retaining groove 11. Upon release, the first retaining member 31 engages with the wall of the retaining groove 11, ensuring a stable connection. During disassembly, pressing the first trigger member 32 again moves the first retaining member 31 to disengage from the retaining groove 11, allowing quick removal. Compared to existing technologies, the cooperation between the first quick-release assembly 3 and the retaining groove 11 enables rapid assembly and disassembly of the body unit 1 and the handwheel 2, forming two separate modules. This design improves portability, facilitates shooting and replacement, enhances flexibility, and significantly increases user convenience.

In some aspects, the handwheel 2 serves as the first main body , and the body unit 1 serves as the second main body. The retaining groove 11 is formed on the handwheel 2, and the first retaining member 31 and the first trigger 32 are movably installed within the body unit 1. This configuration enables the positions of the first quick-release assembly 3 and the retaining groove 11 to be interchanged relative to the previous embodiment.

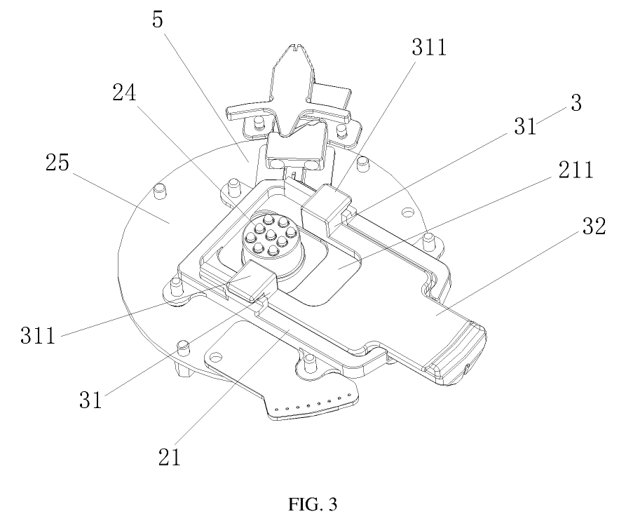

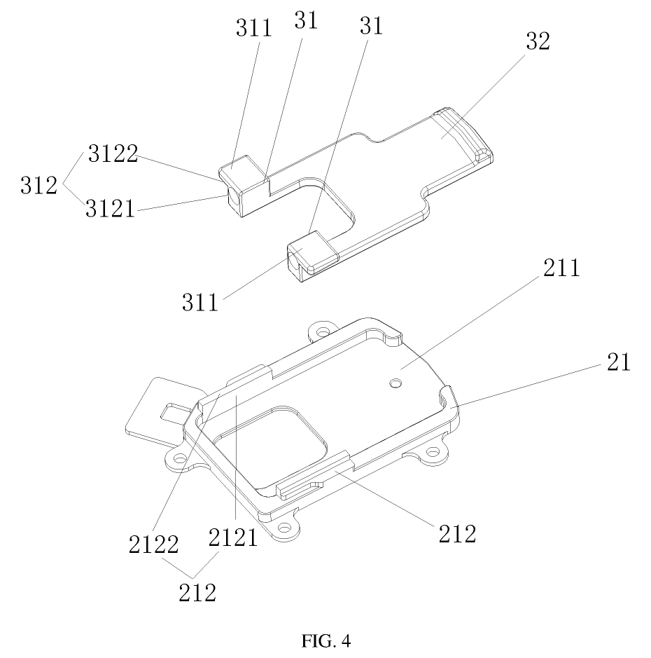

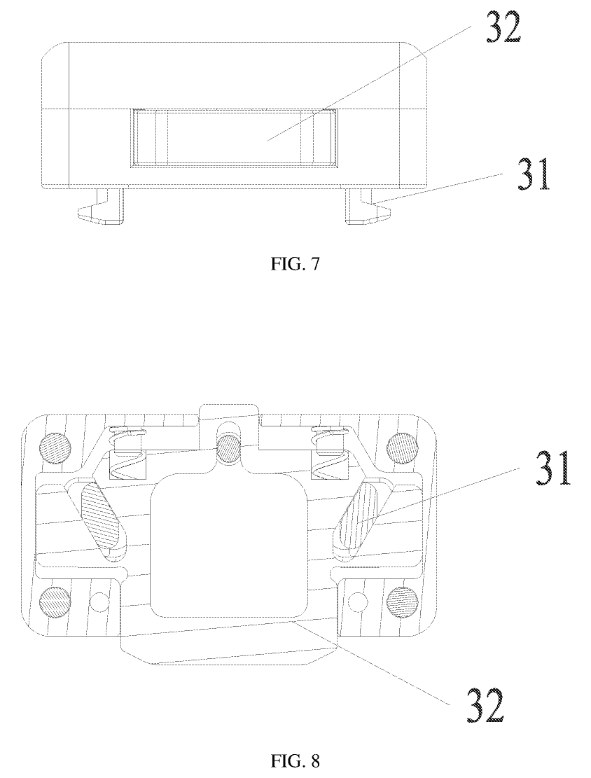

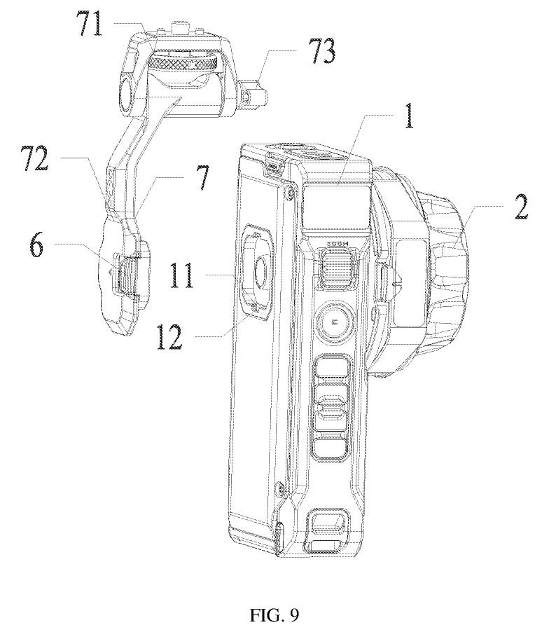

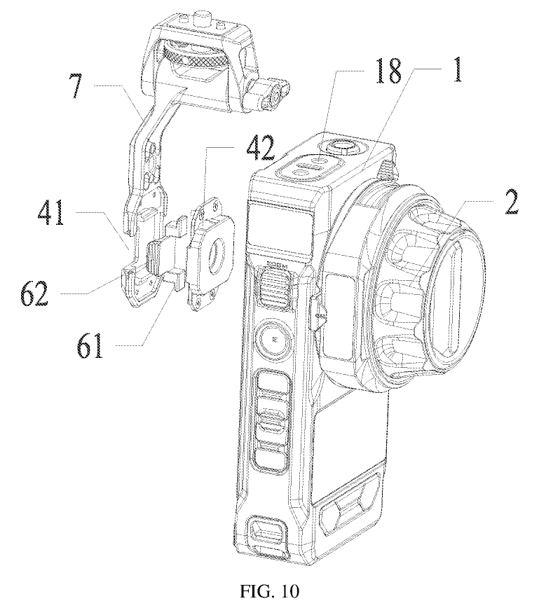

In some aspects, as shown in FIG. 3–4, in one implementation, the first trigger 32 and the first retaining member 31 can be designed as an integrated structure, fixed together to ensure structural stability. As shown in FIG. 7–8, in another implementation, the first trigger 32 and the first retaining member 31 can be designed as a detachable structures, abutting via inclined surfaces.

In some aspects, the handwheel 2 includes a mounting chamber 5 and multiple openings 4 communicating with the mounting chamber 5. The openings 4 include a first opening 41 and a second opening 42. One end of the first trigger 32 is disposed within the handwheel 2, while the other end is exposed outside the handwheel 2 through the first opening 41. One end of the first retaining member 31 is disposed within the handwheel 2, while the other end is exposed outside the handwheel 2 through the second opening 42. Pressing the first trigger 32 drives the first retaining member 31 to move, enabling engagement or disengagement between the first retaining member 31 and the retaining groove 11. This design integrates the first quick-release assembly 3 into the handwheel 2, resulting in a more compact and stable structure.

In some aspects, the handwheel 2 further includes a mounting block 21. The mounting block 21 defines a limiting slide groove 211. The first trigger 32 is slidably connected within the limiting slide groove 211, and the end of the first trigger 32 away from the first retaining member 31 extends through the limiting slide groove 211 and the end of the first trigger 32 is exposed outside the handwheel 2. The limiting slide groove 211 in the mounting block 21 restricts the movement of the first trigger 32 during operation, preventing misalignment.

In some aspects, the first retaining member 31 includes a latch hook 311. The wall of the retaining groove 11 includes one or more notches (e.g., notch 12), and the notch can serve as an entry and exit point for the latch hook 311. When the first trigger 32 moves relative to the mounting block 21, the latch hook 311 can move in and out of the notch 12. When the latch hook 311 moves to align with the notch 12, it can be removed from the notch 12. When the latch hook 311 moves into the retaining groove 11, it engages with the retaining groove 11. The first quick-release assembly 3 further includes a return spring disposed between the first retaining member 31 and the mounting block 21, with its position limited by a hole on the first retaining member 31. During installation, one end of the first trigger 32 extends out of the mounting chamber 5 through the first opening 41. Pressing the first trigger 32 inward from the first opening 41 drives the first retaining member 31 to move within the mounting chamber 5. The latch hook 311 extends out of the mounting chamber 5 through the second opening 42 and aligns with the notch 12. The latch hook 311 enters the retaining groove 11 through the notch 12. Releasing the pressing force allows the latch hook 311 to reset under the elastic force of the return spring, engaging with the wall of the retaining groove 11. One end of the first trigger 32 extends out of the mounting chamber 5 through the first opening 41. During disassembly, pressing the first trigger 32 again moves the latch hook 311 from the retaining groove 11 to align with the notch 12, allowing the latch hook 311 to be removed through the notch 12, thereby enabling quick disengagement between the latch hook 311 and the retaining groove 11.

In some aspects, the inner side of the first retaining member 31 is provided with a sliding limiting surface 312, and the mounting block 21 is provided with a sliding limiting boss 212. The sliding limiting surface 312 includes a first sliding limiting surface 3121 and a second sliding limiting surface 3122. The first sliding limiting surface 3121 and the second sliding limiting surface 3122 are in sliding contact with the side surface 2121 and the top surface 2122 of the sliding limiting boss 212, respectively. This structural arrangement ensures that the first retaining member 31 moves along a defined trajectory, thereby preventing misalignment. In some aspects, the first retaining member 31 includes a latch hook 311, which is configured to abut against the top surface 2122 of the sliding limiting boss 212 and protrude beyond it. This allows the protruding portion of the latch hook 311 to engage with the wall of the retaining groove 11 during the installation process.

In some aspects, two first retaining members 31 are provided, positioned on opposite sides of the first trigger 32 such that the two latch hooks 311 face away from each other. Correspondingly, two retaining grooves 11 are provided to enable a one-to-one connection between the latch hooks 311 and the retaining grooves 11. During assembly, actuation of the first trigger 32 drives the two first retaining members 31 to move synchronously, causing the latch hooks 311 on both sides to simultaneously engage the two retaining grooves 11 within the mounting groove 13 for assembly. Similarly, during disassembly, the latch hooks 311 on both sides move synchronously to shift from the retaining grooves 11 to the notches 12, thereby disengaging from the retaining grooves 11.

In some aspects, the two retaining grooves 11 are symmetrically arranged, and the two first retaining members 31 are also symmetrically disposed, allowing the latch hooks 311 of the two first retaining members 31 to engage with either of the two retaining grooves 11. In practical use, as users have different handling habits, the orientation in which they hold the body unit 1 can vary. If only one retaining groove 11 were provided, the user would need to hold the body unit 1 at a specific angle and align it carefully to facilitate assembly with the handwheel 2. However, with the symmetrical configuration of two retaining grooves 11 cooperating with two symmetrical first retaining members 31, the user can install the handwheel 2 without precise alignment, enabling adaptive installation of the handwheel 2 and the body unit 1 in either orientation. Additionally, during use, the body unit 1 can be rotated 180 degrees to allow handheld operation in an inverted position, thereby further enhancing convenience of use.

In some aspects, the handwheel 2 further includes a handwheel main body 22 and a base plate 23. The handwheel main body 22 is equipped with a mounting chamber 5. The mounting block 21 is disposed within the mounting chamber 5 and fixedly connected to the base plate 23. The side of the base plate 23 facing away from the mounting block 21 is provided with a mounting boss 231. The body unit 1 is provided with a mounting groove 13, and the mounting boss 231 is accommodated within the mounting groove 13. The second opening 42 is located on the side of the mounting boss 231. The retaining grooves 11 are formed on the inner walls of opposite sides of the mounting groove 13. During assembly of the body unit 1 and the handwheel 2, pressing the first trigger 32 actuates the first retaining member 31 to move, aligning the latch hook 311 with the notch 12. At this point, the mounting boss 231 can be aligned and inserted into the mounting groove 13, with the mounting groove 13 constraining the position of the mounting boss 231. Releasing the first trigger 32 allows the return spring to drive the first trigger 32 to move, causing the latch hook 311 to engage with the retaining groove 11, thereby locking the mounting boss 231 within the mounting groove 13. Similarly, during disassembly, moving the first trigger 32 aligns the latch hook 311 with the notch 12, enabling the mounting boss 231 to be removed from the mounting groove 13.

In some aspects, the mounting boss 231 is provided with a terminal through-hole 232. The handwheel 2 further includes a first connector 24 and a circuit board 25. The circuit board 25 is fixedly connected to the base plate 23, and the first connector 24 is electrically connected to the circuit board 25. The body unit 1 includes a second connector 14, which is located within the mounting groove 13. The first connector 24 extends through the terminal through-hole 232 into the mounting groove 13 to electrically connect with the second connector 14. The electrical connection between the first connector 24 and the second connector 14 can be achieved via contact pins or interfaces, enabling communication between the handwheel 2 and the body unit 1. This enables the body unit 1 of the follow focus unit to be controlled via the handwheel 2, facilitating adjustment of camera lens parameters.

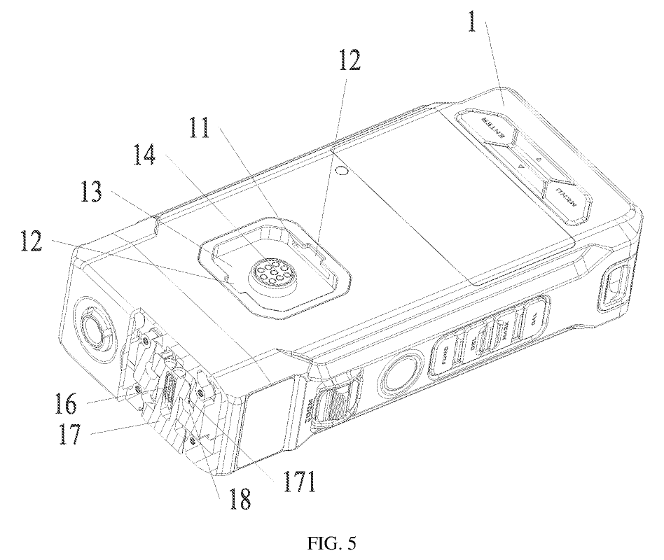

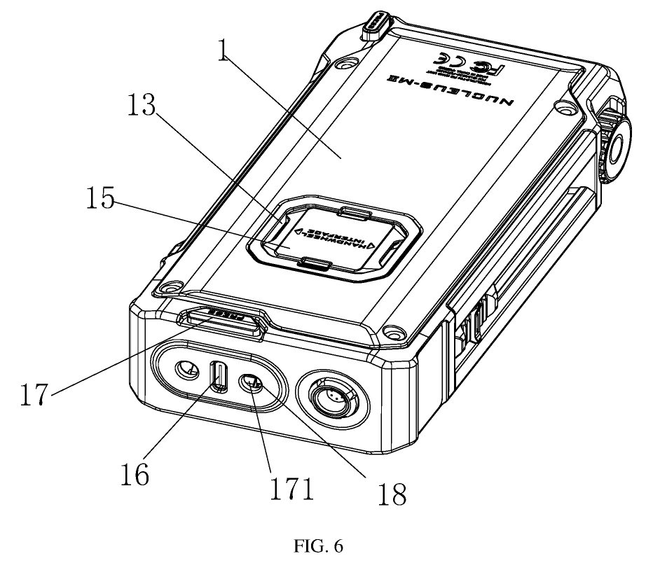

Referring to FIGS. 5-6, in some aspects, the body unit 1 is provided with two mounting grooves 13, located on opposite sides thereof. Both mounting grooves 13 are provided with a second connector 14 and a retaining groove 11. One mounting groove 13 is used for connecting the handwheel 2 during normal operation, while the other mounting groove 13 serves as a spare groove and is covered with an elastic plug 15. The mounting boss 231 of the handwheel 2 can be installed in either of the two mounting grooves 13, allowing for switching between left-handed and right-handed operation, which offers great convenience for the user (e.g., a focus puller). In some aspects, the lens parameter adjustment device further includes an extension bracket 7 and a second quick-release assembly 6. The extension bracket 7 includes a bracket 72 and a connector 71. The connector 71 is rotatably connected to the bracket 72 and is used to connect photographic accessories, such as a monitor, enabling the focus puller to observe focusing conditions. The second quick-release assembly 6 is movably connected to the bracket 72 and includes a second retaining member 61 and a second trigger 62. The second trigger 62 is operable to actuate the second retaining member 61 to engage with or disengage from the wall of one of the retaining grooves 11. The first trigger 32 is operable to actuate the first retaining member 31 to engage with or disengage from the wall of the other retaining groove 11. With this configuration, the user can rotate the handwheel 2 to adjust lens parameters while observing the shooting conditions through the monitor. The quick-release principle of the second trigger 62 and the second retaining member 61 is similar to that of the first quick-release assembly 3 and will not be elaborated here. The connector 71 can include common photographic connection interfaces, such as 1/4-inch or 3/8-inch screw interfaces, for engaging threaded holes on the monitor. The bracket 72 and the connector 71 are movably connected via a knob 73. When the knob 73 is loosened, the bracket 72 and the connector 71 can rotate relative to each other. When the knob 73 is tightened, the bracket 72 and the connector 71 are locked in position.

In some aspects, the body unit 1 further includes an interface 16 for mounting external accessories and a positioning port 18. The body unit 1 is provided with a quick-release locking member 17 for locking or releasing external accessories. The quick-release locking member 17 is elastically connected to the body unit 1, for example, via a spring. The quick-release locking member 17 includes two locking parts 171, which can have inclined surfaces. An external accessory can have a positioning post structure that can be inserted into the positioning port 18. When the external accessory is inserted into the interface 16, the locking parts 171 engage with the positioning post of the external accessory, thereby locking it in place. To release the accessory, pressing the quick-release locking member 17 causes the locking parts 171 to retract together, allowing the positioning post to be removed from the positioning port 18. The locking parts 171 disengage from the external accessory, enabling its release. The quick-release locking member 17 is movably connected to the body unit 1, providing the follow focus unit with the function of quickly attaching and detaching external accessories, thereby enhancing its versatility. In some aspects, the external accessory can have a shape complementary to the locking parts 171 to ensure effective cooperation. For example, the locking parts 171 can have a triangular shape with inclined surfaces, and the external accessory can have a corresponding locking slot. After the external accessory is inserted into the positioning port 18, the locking parts 171 can be secured within the locking slot.

What is claimed is:

1. A lens parameter adjustment device, comprising a first main body, a second main body, and a first quick-release assembly;
the first main body being provided with a retaining groove;
the first quick-release assembly being movably connected to the second main body and comprising a first retaining member and a first trigger, wherein the first trigger is configured to drive the first retaining member to engage with or disengage from a groove wall of the retaining groove; and
one of the first main body and the second main body comprising a body unit, and another one of the first main body and the second main body comprising a handwheel.

2. The lens parameter adjustment device according to claim 1, wherein the second main body is provided with a mounting chamber and one or more openings in communicating with the mounting chamber;
wherein one end of the first trigger is provided within the mounting chamber, and another end of the first trigger is exposed outside the second main body through one of the openings; and
wherein one end of the first retaining member is provided within the mounting chamber, and another end of the first retaining member is exposed outside the second main body through one of the openings, thereby enabling the first retaining member to be actuated by pressing the first trigger to engage with or separate from the retaining groove.

3. The lens parameter adjustment device according to claim 1, further comprising multiple retaining members, wherein two of the multiple retaining members are arranged opposite each other on two sides of the first trigger; and
wherein a quantity of the retaining groove corresponds to a quantity of the multiple retaining members.

4. The lens parameter adjustment device according to claim 1, further comprising multiple retaining members, wherein two of the multiple retaining members are arranged facing away from each other on two sides of the first trigger; and
wherein a quantity of the retaining grooves corresponds to a quantity of the multiple retaining members.

5. The lens parameter adjustment device according to claim 3, wherein a first retaining member of the multiple retaining members comprises a latch hook, and the groove wall of the retaining groove is provided with a notch for entry and exit of the latch hook, thereby enabling engagement and disengagement between the latch hook and the retaining groove;
wherein the latch hook is movable relative to the retaining groove and the notch; and
wherein the latch hook is removable from the notch in response to the latch hook moving into alignment with the notch, and the latch hook is engageable with the groove wall of the retaining groove in response to the latch hook moving into the retaining groove.

6. The lens parameter adjustment device according to claim 4, wherein the retaining groove comprises two retaining grooves that are symmetrically arranged, and the notches of the two retaining grooves are symmetrically arranged; and
wherein two of the first retaining members are symmetrically arranged.

7. The lens parameter adjustment device according to claim 1, wherein the first main body comprises a body unit, and the second main body comprises a handwheel.

8. The lens parameter adjustment device according to claim 7, further comprising multiple mounting grooves; and
wherein two of the multiple mounting grooves are located respectively on two opposite surfaces of the first main body.

9. The lens parameter adjustment device according to claim 8, further comprising an extension bracket and a second quick-release assembly;
wherein the extension bracket comprises a bracket and a connector, and the connector is rotatably connected to the bracket for connecting a photographic accessory;
wherein the second quick-release assembly is movably connected to the bracket, and the second quick-release assembly comprises a second retaining member and a second trigger;
wherein the second trigger is operable to actuate the second retaining member to engage with or disengage from a groove wall of the retaining groove; and
wherein the first trigger is configured to drive the first retaining member to engage with or disengage from a groove wall of another retaining groove.

10. The lens parameter adjustment device according to claim 7, wherein the handwheel comprises a mounting block and a handwheel main body, the mounting block defines a limiting slide groove therein, the first trigger is slidably connected within the limiting slide groove, and an end of the first trigger away from the retaining member extends through the limiting slide groove to exposed outside the handwheel.

11. The lens parameter adjustment device according to claim 7, wherein the handwheel comprises a mounting block and a handwheel main body, an inner side of the retaining member is provided with a sliding limiting surface, the mounting block is provided with a sliding limiting boss; and
wherein the sliding limiting surface is in contact and sliding connection with the sliding limiting boss.

12. The lens parameter adjustment device according to claim 7, wherein the handwheel comprises a handwheel main body, a base plate, and a mounting block;
wherein the handwheel main body defines a mounting chamber;
wherein the mounting block is disposed within the mounting chamber and fixedly connected to the base plate;
wherein the handwheel main body is configured with a first opening;
wherein the first trigger is movably disposed on the mounting block, and an end of the first trigger away from the first retaining member is extendable through the first opening;
wherein a side of the base plate opposite the mounting block is provided with a mounting boss;
wherein a side edge of the mounting boss is provided with a second opening;
wherein an end of the first retaining member away from the first trigger is extendable through the second opening;
wherein the body unit is provided with a mounting groove;
wherein the retaining groove is provided on opposite inner walls of the mounting groove; and
wherein in response to receiving the mounting boss within the mounting groove, the first retaining member is engaged within the retaining groove, thereby locking the mounting boss within the mounting groove.

13. The lens parameter adjustment device according to claim 12, wherein the mounting boss is provided with a first connector;
wherein the handwheel further comprises a circuit board;
wherein the circuit board is fixedly connected to the base plate;
wherein the first connector is electrically connected to the circuit board;
wherein the body unit comprises a second connector;
wherein the second connector is provided within the mounting groove; and
wherein the first connector extends into the mounting groove to electrically connect with the second connector.

14. The lens parameter adjustment device according to claim 7, wherein the body unit further comprises an interface for mounting an external accessory;
wherein the interface is provided with a quick-release locking member for locking or releasing the external accessory; and
wherein the quick-release locking member is movably connected to the body unit.
